(19) United States
(12) Patent Application Publication
(10) Pub. No.: US 2014/0180724 A1
(43) Pub. Date: Jun. 26, 2014

(54) System and Method for Managing a Long Term Care Rider for Whole Life Insurance Policy

(71) Applicant: MASSACHUSETTS MUTUAL LIFE INSURANCE COMPANY, Springfield, MA (US)

(72) Inventors: Paul Strong, Sturbridge, MA (US); Kevin Waterman, South Windsor, CT (US); George Rathbun, Windsor, CT (US); Joel Wolfe, West Hartford, CT (US); Stuart Kwassman, Newington, CT (US)

(73) Assignee: Massachusetts Mutual Life Insurance Company, Springfield, MA (US)

(21) Appl. No.: 13/724,418

(22) Filed: Dec. 21, 2012

(51) Int. Cl. G06Q 40/08

(52) U.S. Cl. CPC G06Q 40/08
USPC 705/4

(57) ABSTRACT

A system and method for managing a whole life insurance policy with a rider for providing an accelerated benefit for covered long term care expenses. The system and method provides for accelerated benefits to be tracked and maintained as a lien against the death benefit of the whole life insurance policy. The lien does not directly affect the face value of the whole life insurance policy and permits dividends to continue to be earned from the whole life insurance policy. The lien is applied against the death benefit and serves to reduce the cash value provided should the policy be surrendered.

### TECHNICAL FIELD

The present invention is in the field of computer-based systems and methods for managing life insurance products. More particularly, the present invention relates to the management of a long term care rider for a whole life insurance policy.

### BACKGROUND OF THE INVENTION

The present invention relates to management of a whole life insurance product with a long term care rider. Whole life insurance is a basic form of permanent life insurance. A whole life insurance policy is designed to pay a death benefit upon the death of the insured. As opposed to a term life insurance policy, which pays a death benefit only if the death of the insured occurs during the term of the policy, whole life insurance is designed to pay the death benefit regardless of how long the insured lives. Whole life insurance policies also typically have level premiums that are payable for a fixed period of time.

Whole life insurance policyholders typically pay premiums in the early years of their contract that are in excess of the cost to fund the early year death benefits. As a result of this overfunding, whole life insurance policies develop cash values. Some or all of the cash value of the whole life policy is typically accessible to the policy owner. So, the policy can be surrendered and the cash value be paid out. Or, whole life policies may also provide for the ability to withdraw some of the cash value as a policy loan. If the policy owner borrows some of the cash value of the whole life insurance policy, the death benefit paid upon the death of the insured is reduced by the amount of the loan.

Another feature of participating whole life insurance policies is that excess returns of the policy may be returned to the policy owner in the form dividends. Typically, these dividends may be paid out in a variety of ways. They can be paid in cash, they can be used to pay all or a portion of the policy premium, or they may be used to purchase additional pieces of death benefit, thus increasing the policy's total death benefit.

Insurance companies maintain computer systems to manage whole life insurance policies. Such computer systems must track the cash value for each policy so that customer service representatives and insurance agents can access the information regarding the policies and provide information regarding the cash value of the policy. The information stored and thus provided by such management systems include information regarding whether the owner of the policy has accessed the cash value of the policy by taking out a policy loan. These systems allow the cash value to be determined should the policy owner surrender the policy and to quickly and efficiently determine any adjustments to the death benefit upon the death of the insured.

Long term care insurance policies are insurance policies that insure against the costs of providing long term care for people who are unable to perform the basic activities of daily living. These insurance policies are not designed to cover expenses for treatment of an illness or particular medical care. Rather, long teen care insurance is designed to cover costs of nursing homes, home care or similar care when the insured is no longer able to care for themselves. Typically, long term care insurance reimburses the owner for long term care expenses that are accrued by the insured up to the maximum value allowed by the terms of the policy. For expenses to qualify as long term care expenses they typically must be incurred by an insured that is chronically ill. Chronically ill is usually defined as a condition that is expected to last at least ninety (90) days and prevents the insured from performing at least two activities of daily living. Activities of daily living are usually defined as bathing, continence, dressing, eating, toileting and transferring. Thus, insureds that receive care due to the inability to perform these activities on their own may have their expenses reimbursed by a long term care policy. Most long term care policies typically include an elimination period. During the elimination period, for example the first ninety (90) days of a chronic illness of the insured, the costs for care of the insured with a chronic illness are not covered.

### SUMMARY OF THE INVENTION

The invention provides an accelerated benefit payment of the death benefit of a whole life insurance policy to cover long term care expenses of the insured. The invention provides for a computer system to manage the complexities involved in the provision of such an accelerated benefit.

The invention permits an owner of a whole life insurance policy to accelerate the death benefit of the policy to cover long term care expenses incurred by the insured. The invention takes the form of rider for accelerated benefits that is purchased with the whole life insurance policy. This rider provides for the payment of long care term expenses by reducing the death benefit that is paid upon the insured's death. To maintain the whole life insurance policy, these accelerated benefit payments do not directly reduce the face value of the whole life insurance policy. Rather, the amounts of the accelerated payments under the long term care rider create a lien against the whole life insurance policy's death benefit. Thus, since the whole life policy face amount is not reduced, the policy owner may continue to receive dividends based on the face amount of the policy.

In operation, a whole life policy is issued to a policy owner for a face amount representing the amount payable to a beneficiary upon the death of the insured. The whole life insurance policy is a permanent life insurance policy and, thus, is intended to remain in force throughout the lifetime of the insured. To obtain the full death benefit of the whole life insurance policy, periodic premium payments must be paid by the policy owner throughout the life of the policy. These premium payments are designed to remain level during the life of the policy. As the payments are level and the risk of death increases over time, the initial payments are greater than required and therefore provide the necessary reserve to fund the death benefit amount anticipated to be paid in a later year. A portion of the excess amount of the premium payments are retained within the life insurance policy as cash value. The cash value of the whole life policy represents the policy owner's share of the funds that the insurance company has retained across the issued policies. Excess returns on these retained funds are returned to the policy owners in the form of dividends based on the face amount of each policy. The cash value of each policy increases over time as the owner makes periodic premium payments.

Dividend payments on the face amount of a whole life insurance policy are useful to the policy owner as these payments can be used to purchase additional life insurance coverage. These additional pieces of coverage are called paid-up additions. These additions both increase the policy death benefit and increase the cash value of the policy. Dividend payments may also be used to decrease the premium payments due on the policy. Thus, in the later years of the policy all of the premium payment may not be required to be paid out of pocket by the policy owner.

The cash value of the whole life insurance policy is generally available to the policy owner in a number of ways. However, accessing the cash value generally reduces the death benefit that is paid upon the death of the insured. The policy owner can generally borrow against the cash value of the policy within limits set by the policy. This includes both the basic policy cash value as well as the cash value associated with any paid up additions. The policy owner can also generally fully surrender the policy and receive the cash value of the policy subject to any fees (if any) set forth by the policy. Such surrender terminates the insurance policy. The policy owner can also reduce the face amount of the policy, resulting in a pro-rata release of the cash value of the policy.

The invention provides an additional method for the policy owner to access the death benefit of the policy. The invention provides for the death benefit to be accessed to pay for covered long term care expenses of the insured. This is particularly useful as a whole life insurance policy is frequently purchased in order to ensure that a nest egg is available to pass to the next generation. As long term care expenses are typically incurred when there may not be an income stream to pay for such expenses, such expenses are frequently borne by the family of the insured. Where the insured has a whole life insurance policy, accessing the death benefit of the policy to pay for these long term care expenses may be the most efficient and expedient manner of reducing the burdens of all involved with the care of the insured, while maintaining most of the family's assets outside of the whole life insurance policy.

In operation the long term care rider is purchased in conjunction with the initial purchase of the whole life insurance policy. At the time of purchasing the whole life insurance policy and the long term care rider, a base benefit pool for the long care rider is established. This base benefit pool is the portion of the whole life insurance policy face amount which is available for acceleration. The residual face amount is equal to the policy face amount minus the base benefit pool minus the base death benefit liens. Also at the time of purchase or during the life of the policy, a dividends benefit pool may be established. The dividends benefit pool enables the paid-up additions to the benefit pool to be included for acceleration. Based on the base benefit pool and a selected benefit period a maximum periodic benefit is established. Typically, this is a maximum monthly amount of long term care expenses that will be reimbursed under the provisions of the long term care rider. The maximum monthly amount is determined for each month that policy may be retained in force at the time the policy and the rider are purchased. This maximum monthly benefit may be decreased based on base face amount reductions during the life of the policy. This maximum monthly benefit is intended to ensure that the benefit will extend throughout a selected benefit period. However, the actual period that benefits are paid under the long term care rider may be shorter or longer than the selected benefit period. For example, if the claims paid for a policy month are less than the maximum monthly benefit, the unused benefit may extend the period over which long term care benefits are paid. In addition, the dividends benefit pool may also extend the period over which long care benefits are paid.

Insurance companies use policy administration systems for maintaining individual policy data, managing policy administration and providing customer service. Existing policy administration systems are not designed to fully address accelerated long term care expense reimbursements as required by the whole life insurance policy with the long term care rider of the present invention. As the number of life insurance policies under which benefits are accelerated to reimburse long term care expenses may be a small number in relation to total number of policies administered, it is advantageous to include an additional processing module to address the accelerated payments under the long term care rider. The advantages of providing a separate module include the ability to continue to use existing processing systems without change and the necessity to only train a select group of customer service and other personnel to process long term care claims.

### BRIEF DESCRIPTION OF THE DRAWINGS

FIG. 1 is a diagram of an architecture for a typical system according to the present invention.

FIG. 2 is a flow chart of steps in a typical process according to the present invention.

### DETAILED DESCRIPTION OF THE INVENTION

The invention is directed toward computer-based systems and methods for administering a whole life insurance policy with rider for accelerating benefit payment to reimburse long term care expenses incurred by the insured.

The invention provides for a computer system and method to manage the complexities involved in the provision of such an accelerated benefit. The system and method administers whole life insurance policies including a rider that permits the policy owner to access the death benefit of the policy to cover long term care expenses incurred by the insured. The administered rider provides for the payment of long care term expenses by reducing the death benefit that is paid upon the death of the insured. The accelerated benefit payments do not directly reduce the face value of the whole life insurance policy. Rather, the amount of the accelerated payments made under the long term care rider constitutes a lien against the whole life insurance policy's death benefit.

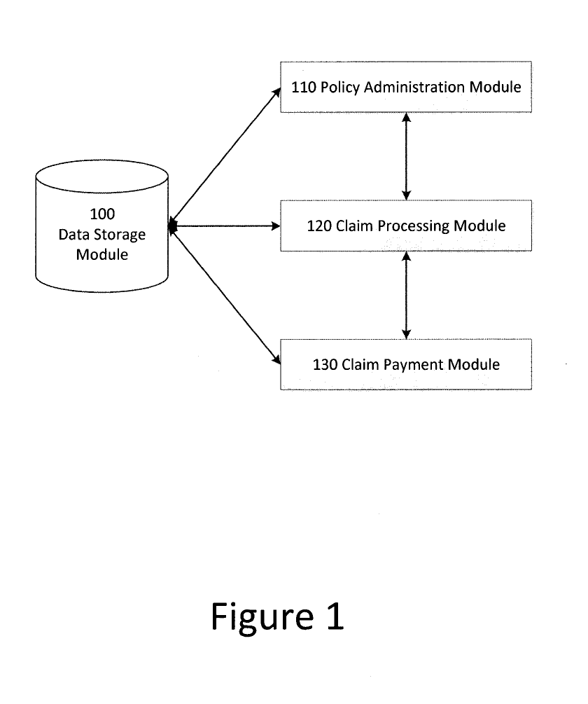

Referring to FIG. 1, a policy administration module 110 interacts with a data storage module 100 to maintain information on various insurance policies including whole life insurance policies. The data storage module may include various data storage hardware and database and other software to maintain data regarding insurance policies. This data can be accessed by various computers and software over a computing network. Various computers, computing hardware and computing software packages are organized to form computing modules. The computing modules function as set forth in more detail below.

Whole life insurance policies are issued to policy owner's with a face amount representing the death benefit paid to a beneficiary upon the death of the insured. The relevant claim information regarding each policy is stored in the data storage module 100 and is readily accessed and modified by the policy administration module 110. These whole life insurance policies are permanent life insurance policies and the policy administration module 110 typically would be used to cause the death benefit to be paid upon the death of the insured. The policy administration module 110 is used to process premium payments and to issue notices in the event that a policy is terminated for failure to comply with the terms of the policy such as the failure to pay premiums as set forth by policy. The policy administration module 110 is also used to track the cash value of the whole life insurance policies. Information regarding each policy's dividends and cash value are provided to policy owners and agents through the policy administration module 110. Customer service representatives can access the policy administration module 110 in order to provide information to policy owners and agents regarding the status of policies.

The policy administration module 110 provides for general tracking and managing of policy owner's access to the cash value of the whole life insurance policy. Loans taken out by policy owners against the cash value of the policy are approved and administered through the policy administration module 110. The policy administration module 110 is also used to track and administer the withdraw of the cash value derived from dividend payments. Further, the policy administration module 110 is used to terminate a policy when a policy owner elects to surrender the policy and receive the cash value of the policy. The cash value subject to any fees set forth by the policy is calculated and the policy is terminated through the policy administration module 110.

The invention provides a claim processing module 120 to manage procedures related to the payment of accelerated benefits under the long term care rider. In the preferred embodiment, the claim processing module 120 is a discreet processing module. The discreet module allows for the implementation of the method and system of the present invention without significantly altering existing policy administration systems and methods. As the payment of accelerated benefits under the long term care rider of the present invention constitute a lien against the policy's death benefit, the various calculations regarding dividends and premiums may continue to be processed by policy administration module 110 based on information provided by claim processing module 120. As the number of policies that require payment of accelerated benefits under the long term care rider is likely to be relatively small, a discreet claim processing module 120 is used to track and approve accelerate benefits paid in accordance with the long term care rider. This permits a small team of customer service representatives, life product development representatives and other claim processing personnel to be trained to operate claim processing module 120. As limited changes are required to be made to the policy administration module 110, the customer service representatives and personnel that operate and maintain the policy administration module 110 require only minimal retraining. Changes to policy administration module 110 include automated premium reductions based on the long term care rider premium credits. However, in circumstances where a significant volume of long term care claim processing is required the claim processing module 120 may be incorporated in the policy administration module 110.

Claims processing module 120 is designed specifically to validate and approve the payment of accelerated benefits under the long term care rider a whole life insurance policy. Claims processing module 120 is designed to interact with other processing modules so as not to duplicate tasks. General information regarding the policy can be obtained from policy administration module 110 by the claim processing module 120. Claim payment activities such as payment check issuance may be accomplished using a processing module or modules shown as claim payment module 130. Claim payment module 130 may thus handle claim payment and check issuance for a number of different types of insurance products. Thus claim processing module 120 is dedicated to managing and tracking the accelerated benefits under the long term care rider.

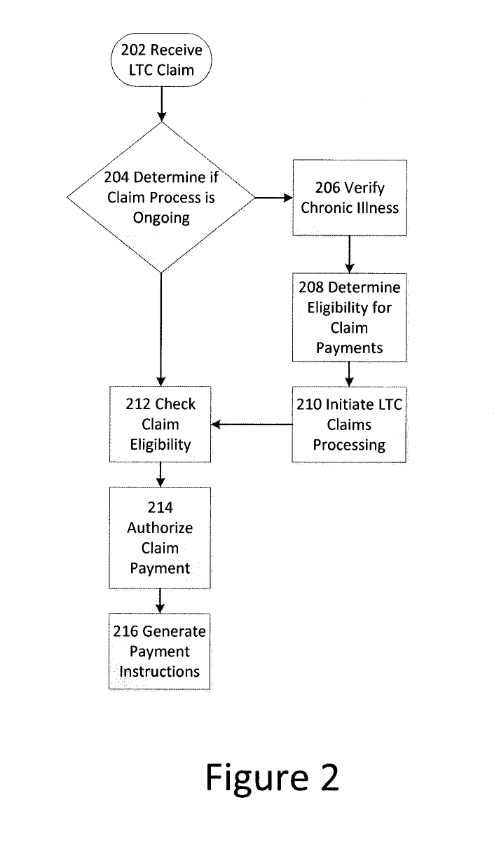

Claims processing module 120 is used to process claims for accelerated benefits under the long term care rider as illustrated in FIG. 2. Claims for accelerated benefits under the long term care rider are processed by specially trained personnel. Accordingly, such claims are routed to personnel that operate claim processing module 120. The method of processing claims under the long term care rider is triggered by receiving a claim for reimbursement of long term care expenses incurred by the insured as shown in step 202. At step 204 it is determined whether long term care claim processing is ongoing. If claim processing is not ongoing, this is the first claim for accelerated benefits in accordance with the rider. To process a first claim or accelerated benefits, at step 206, a verification that the insured is chronically ill is required. Under the long term care rider, expenses related to the care of the insured are reimbursed when the insured is chronically ill. A verification of chronic illness requires that a licensed health care provider certifies that the insured is unable to perform, without substantial assistance from another person, at least two activities of daily living for a period that is expected to last at least ninety consecutive days due to the loss of functional capacity or that the insured has severe cognitive impairment. Activities of daily living are defined as 1) bathing: the washing of oneself by sponge bath, or in either a tub or shower, including the task of getting in or out of the tub or shower; 2) continence: the ability to maintain control of bowel and bladder function, or, when unable to maintain control of bowel or bladder function, the ability to perform associated personal hygiene (including caring for a catheter or colostomy bag); 3) dressing: putting on and taking off all items of clothing and any necessary braces, fasteners, or artificial limbs; 4) eating: feeding oneself by getting food to the body from a receptacle (such as a plate, cup or table) or being fed by a feeding tube or intravenously; 5) toileting: getting to and from the toilet, getting on and off the toilet, and performing associated personal hygiene and 6) transferring: moving into or out of a bed, chair, or wheelchair. Severe cognitive impairment is defined as a deficiency in the insured's short or long term memory, orientation as to person (such as the person's identity), place (such as the person's location) and time (such as day, date and year), deductive or abstract reasoning, or judgment as it relates to safety awareness. Severe cognitive impairment typically includes the deterioration of intellectual capacity from Alzheimer's disease or similar forms of irreversible dementia. Expenses related to long term care are typically incurred at the end of life and accessing the value of the whole life insurance policy may be a financially advantageous method of providing for such care. The long term care rider provides for reimbursement of cost incurred for care of the insured when chronically ill. However, in order to accelerate the benefit payment to cover expenses, the insured must be certified to be chronically ill. The claim processing module 120 is used to record that such a certification has been made. Once such a certification is recorded, claim processing can be permitted. The certification is thus required to process the first claim for accelerated benefits under the long term care rider, but no additional certification is required to process additional claims.

In addition to verification of chronic illness at step 206, a determination of eligibility for claim payment is conducted at step 208. The long term care rider contains provisions under which accelerated benefits will be paid. In particular, the long term care rider sets forth an elimination period set at the time of purchase of the rider. The elimination period is the number of days that the insured must receive covered services while the rider in force and the insured is certified as chronically ill before accelerated benefits will be paid. The accelerated benefits are thus intended to be used where the insured has extended expenses due to long term care needs. Thus, claim processing module 120 is used to determine and record that the provisions of the long term care rider such as satisfying the elimination period have occurred. The provisions for eligibility such as the elimination period need only to be satisfied once. Thus, the claim processing module 120 causes the information that the required provisions have been met to be stored and permits users such as customer service representatives to access this information.

After steps 206 of verifying chronic illness and 208 of determining eligibility, the processing of accelerated benefits under the long term care rider are initiated at step 210. As discussed above, policy administration module 110 can continue to be used to process premium payments and dividends of the whole life policy as the face value of the policy is not directly altered by the acceleration of benefits under the long term care rider. However, the acceleration of benefits does constitute: a lien against the death benefit. Accordingly, an indication must be made in policy administration module 110 that benefits are being accelerated under the long term care rider. This indication is used to ensure that processes performed using policy administration module 110 properly take into account the lien applied against the death benefit. For example, a premium credit is applied based on the amount accelerate benefits paid under the long term care rider. The indication also serves to ensure that any future payment under the policy is adjusted by claim processing module 120 in accordance with the lien maintained by claim processing module 120. The acceleration of the benefit under the long term care rider may also trigger other actions with regard to the whole life insurance policy or other riders attached to the whole life insurance policy. For example, another rider may also accelerate the payment of the benefit under defined circumstances. Typically, such another accelerated benefit rider is terminated upon the acceleration of benefit under the long term care rider. The claim processing module 120 is used with the policy administration module 110 to cause any required actions such as the termination of another accelerated benefit rider to occur.

Once claim processing is initiated by claim processing module 120, claims are periodically processed for payment. Typically, claims are processed weekly. However, where required by specific rules or regulations, claims may be processed more quickly as they are received. Claims are received in the form of covered expenses for long term care under a plan of care. The plan of care is a written individualized plan of services prescribed by a licensed health care practitioner based upon an assessment that states that the insured is chronically ill. The plan of care specifies the type, frequency, and the providers of the services most suitable to meet the insured's long term care and the costs, if any, of those services. The long term care rider provides for reimbursement of long term care services. These long term care services are the diagnostic, preventative, therapeutic, curing, treating, mitigating, and rehabilitive services and maintenance or personal care services which are required by the insured when chronically ill and are provided pursuant to the plan of care prescribed by a licensed health care practitioner. Thus, claims must be verified to be for long term care services that have been incurred by the insured.

Additionally, expenses are covered up to the maximum monthly benefit amount for the policy month. The long term care rider provides for acceleration of a portion of the death benefit of the whole life insurance policy. At the time of the purchase of the whole life insurance policy with the long term care rider, a base benefit pool is established. This base benefit pool is the portion of the policy face amount that is available for acceleration. The portion of the whole life insurance policy that is not available for acceleration is the residual face amount. The residual face amount cannot be changed after the policy is issued. A selected benefit period is also selected at the time the policy is purchased. The accelerated benefits are designed to be payable over this selected benefit period. The monthly maximum benefit is calculated so that the base benefit pool is available throughout the selected benefit period. Thus, claims in excess of the monthly maximum benefit are not reimbursed. The maximum monthly benefit schedule is provided to the policy owner for each policy year at the time of purchase of the whole life insurance policy with the long term care rider in the policy contract form. The maximum monthly benefit may be reduced if the face amount of the policy is reduced.

The policy owner may also be provided with the option to elect to have the maximum monthly benefit increased. The maximum monthly benefit increase option provides the ability beginning after the insured turns age 61 to access the accelerated benefit more quickly by increasing the maximum monthly benefit. The maximum monthly benefit increase option does not increase the total amount of the lifetime benefit, but only increases the maximum amount available for payment each month. Beginning at age 61 (or the first policy anniversary if the issue age is 61 or greater) the maximum monthly benefit at issue will be increased each year for twenty-five years by an amount equal to 4% of the initial maximum monthly benefit. Because a larger amount can be paid each month, the period during which claims may be paid is likely to be shorter than the selected benefit period. The maximum monthly benefit increase option includes additional costs that are reflected in the premiums required to keep the policy in force.

The policy owner at the time that the whole life insurance policy with long term care rider is purchased may elect to have paid-up additions purchased with the policy's dividends and have those additions included for acceleration. The amount of paid-up additions includible for acceleration is referred to as the dividends benefit pool. There is a charge to create a dividends benefit pool. The charge is a percentage of the dividend and is deducted from the policy dividend paid before the purchase of paid-up additions. The charge will be a higher percentage if the maximum monthly benefit option is also selected. As a result, paid-up additions face amounts will be lower if paid-up additions are elected for acceleration (this is due to the charge referenced above). The maximum lifetime rider benefit is the sum of the base benefit pool and the dividends benefit pool. The maximum lifetime rider benefit is the maximum amount of accelerated benefits that can be paid under the long term care rider. The actual period during which benefits are paid under the long term care rider may be shorter or longer than the selected benefit period. If the claim for benefits for a policy month is less than the maximum benefit any unused amounts in the base benefit pool may extend the period over which accelerated benefits are paid. The dividends benefit pool may also extend the period over which accelerated benefits are paid. The maximum monthly benefit increase option may decrease the period over which accelerated benefits are paid.

The claim processing module 120 is used to access policy data through policy administration module 110 at step 212. Based on the policy data, the claim processing module 120 determines the monthly maximum benefit and determines whether the claims for benefit received exceed the monthly maximum benefit. The policy data provided by the policy administration module 110 is reviewed to determine if there are any special circumstances or exceptions that would prevent payment of accelerated benefits. If there are no policy circumstances or exceptions preventing the payment of accelerated benefits and if the claims are for covered long term care services and are within the monthly maximum benefit the claims are eligible for payment. When claims are determined to be eligible for payment, claim processing module 120 is used to notify designated personnel that claim is to be paid. The information regarding the accelerated benefits and the covered long term care services are stored by claim processing module 120. Also when claims are determined to be eligible for payment a short term indication is added to the policy information presented by the policy administration module 110. This short term indication provides notice that long term benefit claims are being processed. The short term indication is presented to users of policy administration module 110 and prevents other actions from occurring with regard to whole life insurance policy while the accelerated long term care benefit claims are being processed. For example, the policy cannot be terminated or the death benefit paid while the benefit claims are being processed.

A short time after determining that the benefit claims are eligible for payment, the claim processing module 120 is used to authorize accelerated benefits at step 214. The claim processing module 120 is used to confirm that all required personnel have confirmed that the claim information is complete and accurate. The claim processing module 120 again is used to access the policy administration module 110 to verify that there are no circumstances or exceptions that prevent the payment of accelerated benefit claims. The claim processing module 120 will pass the tasks of payment to claim payment module 130. Accordingly, claim processing module 120 is used to verify that the essential information such as the payment address is the same when accessed by policy administration module 110 and claim payment module 130. Any discrepancies between the information provide through policy administration module 110 and claim payment module 130 are verified and corrected through use of claim payment module 130. Upon confirmation that the all requirements for payment of submitted claims are met, the claim processing module 130 is used to authorize the claim payments. The data regarding the authorized claim payments are recorded. The time between executing step 212 and step 214 is short, typically only one day or less. Upon authorization at step 214 the short term indication regarding long term claim benefit in policy administration module 110 is removed.

At step 216, upon authorization of accelerated benefit payments, claim processing module 120 is used to generate payment instructions which are provided to claim payment module 130. In accordance with these instructions, claim payment module 130 issues the appropriate checks to cause the accelerated benefit payments to be made in accordance with the long term care rider. The claims processing module 120 also is used to calculate federal and state tax withholdings. Payment of the accelerated benefits under the long term care rider does not directly reduce the base face value or base dividend paid up additions face value of the whole life insurance policy. The lien that is established does have several effects on the whole life insurance policy. The claims processing module 120 provides information to policy administration module 110 that provides for proper adjustments to be applied for transactions and quotes after accelerated benefits have been paid. This information is used to process adjusted cash value quotes, adjusted maximum loan value quotes, adjusted death benefit quotes, adjusted surrender value quotes, determination of long term care premium credits, eligible partial withdrawals and eligible face value reduction amounts. The base face value may not be reduced to an amount less than the total of the residual face amount and base death benefit lien. As a result of a withdrawal, the base dividend paid up additions face value may not be reduced to an amount less than base dividend paid up additions death benefit liens.

The claims processing module 120 provides the necessary information to complete transactions based on the quotes.

The claim processing module 120 is also used to track the amount the accelerated benefit paid. The amount constitutes a lien against the benefit of the whole life insurance policy. This data is used to produce periodic statement for the policy owner, such as monthly and annual statements. The claim processing module 120 is also used to provide this information in the event that the insured dies and the death benefit paid is reduced by the lien. The information is also provided in the event that the policy owner surrenders the policy. The cash value paid upon surrender of the policy is also reduced based on the lien against the benefit. As noted above, the claims processing module 120 is used to provide an indication with the information provided by the policy administration module 110 that accelerated benefits are being paid under the long term to care rider. This ensures that policy actions, such as paying the death benefit, are not taken without input from the claim processing module 120. Similarly, the claim processing module 120 is used to check with the policy administration module 110 to ensure that any general actions taken with regard to the policy such as partial withdrawals and base policy decreases are taken into account when authorizing accelerated benefit payments under the long term care rider.

What is claimed is:

1. A computer system for managing a whole life insurance product with a long term care rider for paying a death benefit upon the death of an insured and accelerating benefit payments for long term care expenses incurred by the insured while alive, said system comprising:
a data storage module that stores policy information associated with said whole life insurance product with a long term care rider,
a policy administration module that processes at least some of said information associated with said whole life insurance product with a long term care rider to provide information including current status and current policy values and that enables revision of said policy information including revision of information regarding premiums paid and revision of information regarding policy values,
a claim payment module that issues accelerated benefit payments due under the long term care rider, and
a claim processing module that interacts with said policy administration module and said claim payment module, that tracks benefit values eligible for acceleration including a base benefit pool representing the portion of the whole life policy face amount eligible for acceleration, that verifies that information has been received documenting that the insured is chronically ill, that verifies that long term care expenses claimed are eligible for payment under the long term care rider, that verifies that claimed expenses are within limits set forth by the long term care rider for payment, that authorizes payment of accelerated benefit payments by said claim payment module, and that tracks the accelerated benefit payments paid under the long term care rider and maintains the amount of a lien applied against the base benefit pool.

2. The system according to claim 1 wherein the policy administration module processes premium payments and dividend payments for policies with the long term care rider and for policies without the long term care rider.

3. The system according to claim 1 wherein the claim processing module is used to adjust payment of the death benefit paid to a beneficiary upon death of the insured by reducing the death benefit by the amount of the lien.

4. The system according to claim 1 wherein the claim processing module is used to adjust by at least the amount of the lien a cash value paid upon surrender of the policy by a policy owner.

5. The system according to claim 1 wherein the claim processing module is used to adjust a maximum loan value that is available under the policy.

6. The system according to claim 1 wherein the claim processing module is used to determine a premium credit based on the amount of the lien.

7. The system according to claim 1 wherein the claim processing module is separate and distinct processing module from the policy administration module.

8. The system according to claim 1 wherein the claim processing module verifies that the claimed expenses are within a monthly maximum benefit.

9. The system according to claim 1 wherein the claim processing module verifies that the age of the insured has exceed a predetermined value and applies an increased monthly maximum benefit value for a series of months after such verification.

10. The system according to claim 1, wherein the claim processing module determines that the claimed expenses do not exceed a lifetime maximum benefit amount.

11. The system according to claim 1, wherein the claim processing module provides information to the policy administration module to calculate eligible face value reduction amounts such that the base face value is not reduced to an amount less than the total of a residual face amount and said lien.

12. The system according to claim 1, wherein the claim processing module provides information to the policy administration module to calculate eligible partial withdrawals such that partial withdrawals do not exceed a difference of a base dividend paid up additions face value and the lien.

13. The system according to claim 1, wherein the benefit values eligible for acceleration further include a dividends benefit pool representing paid-up additions to the whole life policy purchased with the policy's dividend eligible for acceleration and the lien is applied against the base benefit pool and the dividends benefit pool.

14. A computer implemented method of administering and managing a whole life insurance policy with a long term care rider, the method comprising:
storing information in a data storage device regarding the whole life insurance policy and long term rider, the long term care rider being a rider purchased concurrently with the whole insurance policy and providing for acceleration of the death benefit for reimbursement of covered long term care expenses of the insured when the insured is chronically ill, the information stored including data regarding the cash value of the whole life insurance policy;
periodically revising the information regarding the whole life insurance policy through a policy administration module, the revised information including data regarding premium payments, the revising including calculating a dividend, if any, due under the whole life insurance policy, the dividend calculations based on the death benefit stored without regard to any accelerated benefits paid under the long term care rider, the revised information including data regarding dividends and any additional coverage purchased under the whole life insurance policy with dividends;
receiving claims for payment of accelerated benefits under the long care term rider through a claim processing module;
authorizing an initial accelerated benefit payment under the long term care rider, initial authorization including performing a verification that the insured is chronically ill and a verification that payment of accelerated benefits is eligible under the conditions of the long term care rider;
periodically processing received claims for payment of accelerated benefits under the long term care rider through the claim processing module, the periodic processing including a determination that the claims do not exceed a periodic maximum benefit amount and that the total claims do not exceed a lifetime maximum benefit amount, the periodic processing including a determination that the claims are for covered long term care expenses incurred by the insured;
periodically issuing payments through a claim payment module based on the periodic payment of received claims; and
maintaining a lien against the death benefit of the whole life insurance policy in the amount of the accelerated benefits paid under the long term care rider.

15. The method of claim 14 wherein the calculation of dividends is not directly affected by the lien maintained against the death benefit.

16. The method of claim 14 further including the step of issuing a death payment upon the death of the insured that is reduce by the amount of the lien.

17. The method of claim 14 further including the step of terminating the whole life insurance policy upon surrender of the policy by the policy owner, the step of terminating including issuing a payment according the cash value of the whole life insurance policy that is reduced in accordance with the lien.

18. The method of claim 14 further including the step of authorizing a loan against the cash value of the policy, wherein the maximum loan value is reduced in accordance with the lien.

19. The method of claim 14 further including the step of authorizing premium credits based on the amount of the lien.

20. The method of claim 14 wherein the periodic maximum benefit amount is increased in for a series of periods after the insured has reached a certain age.

21. The method of claim 14 wherein the benefit from additions to the whole life insurance policy purchased with dividends from the whole life insurance policy are accelerated under the long term care rider.

22. The method of claim 14 wherein the periodic maximum benefit amount is determined so as to provide for accelerated benefit payments over a selected benefit period.

23. The method of claim 14 further including the step of authorizing a face value reduction amount such that the base face value is not reduced to an amount less than the total of a residual face amount and said lien,

24. The method of claim 14 further including the step authorizing a partial withdrawal. As a result of a withdrawal, the base dividend paid up additions face value may not be reduced to an amount less than base dividend paid up additions death benefit liens.
